(19) United States
(12) Patent Application Publication
(10) Pub. No.: US 2017/0007858 A1
(43) Pub. Date: Jan. 12, 2017

(54) Fall Arrest System

(71) Applicant: David Metcalf, Cramlington (GB)

(72) Inventor: David Metcalf, Cramlington (GB)

(21) Appl. No.: 15/205,032

(22) Filed: Jul. 8, 2016

(30) Foreign Application Priority Data
Jul. 11, 2015 (GB) 1512247.6

(51) Int. Cl. A62B 1/22

(52) U.S. Cl. CPC A62B 1/22

(57) ABSTRACT

A system for rendering safe a site above which an individual is operative at height which comprises at least one self-inflating fall arrest unit in a fully inflated state is arranged at a ground location on the site. At least one of the self-inflating fall arrest units in a fully inflated state is linked to at least one other fully inflated self-inflating fall arrest unit. Each of the self-inflating fall arrest units comprise at least one battery-powered fan. A method of rendering safe a site above which an individual is operative at height is also described.

### CROSS REFERENCE TO RELATED APPLICATIONS

This application claims priority from United Kingdom Patent Application No. 15 12 247.6, filed Jul. 11, 2015, the entire disclosure of which is incorporated herein by reference in its entirety.

### BACKGROUND OF THE INVENTION

1. Field of the Invention

The present invention relates to a fall arrest system for rendering safe a site above which an individual is operative at height. More particularly, the present invention relates to a self-inflating fall arrest unit.

2. Description of the Related Art

Falls from a height constitute one of the major causes of injury at work, for example on construction sites. Applying “Work at Height Regulations” and maintaining a high standard of safety remain a constant challenge for all construction site managers.

The term “fall arrest” relates to a mechanism which safely stops a person who is falling. Fall arrest systems must be positioned beneath and around sites where individuals are working or are operative at a height, for example, where roofers are constructing a roof or installing solar panels; where builders are working at a height; where engineers are carrying out maintenance work on airplane wings; and where actors are performing dangerous maneuvers on film sets, to name but a few examples.

Known fall arrest systems include nets suspended around the site where an individual is working or is operative at a height, harnesses and/or life lines worn by an individual which are anchored to a fixed point and inflatable air bags, again placed around the site.

However, these known inflatable air bags are heavy and cumbersome, making them difficult to move to a site where they are required, for example a construction site, and subsequently maneuver into position. These known inflatable air bags also rely on petrol-driven pumps to keep them erect. As well as requiring a substantial amount of petrol for their operation, the fumes from these petrol-driven pumps are unpleasant for workers and are not at all environmentally friendly.

The present proposal provides a solution which overcomes the afore-mentioned problems.

### BRIEF SUMMARY OF THE INVENTION

According to an aspect of the present invention, there is provided a system for rendering safe a site above which an individual is operative at height, comprising: at least one self-inflating fall arrest unit in a fully inflated state arranged at a ground location on said site, wherein said at least one self-inflating fall arrest unit in a fully inflated state is configured to be linked to at least one other fully inflated self-inflating fall arrest unit and each said self-inflating fall arrest unit comprises at least one battery-powered fan.

The system may comprise a plurality of self-inflating fall arrest units in a fully inflated state arranged at a ground location on said site, wherein each of said plurality of self-inflating fall arrest units in a fully inflated state is linked to at least one other fully inflated self-inflating fall arrest unit.

According to a second aspect of the present invention, there is provided a method for rendering safe a site above which an individual is operative at height, comprising the steps of: placing a plurality of self-inflating fall arrest units at a ground location on said site, wherein said self-inflating fall arrest units are in a deflated state; actuating at least one battery-powered fan inside each of said plurality of self-inflating fall arrest units; allowing each of said plurality of self-inflating fall arrest units to self-inflate to a fully inflated state; and locking each of said plurality of self-inflating fall arrest units in a fully inflated state to at least one other fall arrest unit in a fully inflated state.

### BRIEF DESCRIPTION OF THE DRAWINGS

FIG. 1 shows a typical site on which the embodied invention may be deployed;

FIG. 2 shows an individual carrying two units of the embodied invention;

FIG. 3 shows a perspective view of a single unit of the embodied invention;

FIG. 4 shows a plurality of units of the embodied invention being set out on the ground;

FIG. 5 shows an individual unpacking a self-inflating fall arrest unit embodied in the present invention;

FIG. 6 shows a battery and two fans of an embodiment of the invention;

FIG. 7 shows two self-inflating fall arrest units of the embodied invention linked together;

FIG. 8 shows a plurality of self-inflating fall arrest units of the embodied invention linked together;

FIG. 9 shows a perspective view of the fasteners embodied in the present invention; and

FIG. 10 shows an individual packing away a self-inflating fall arrest unit embodied in the present invention.

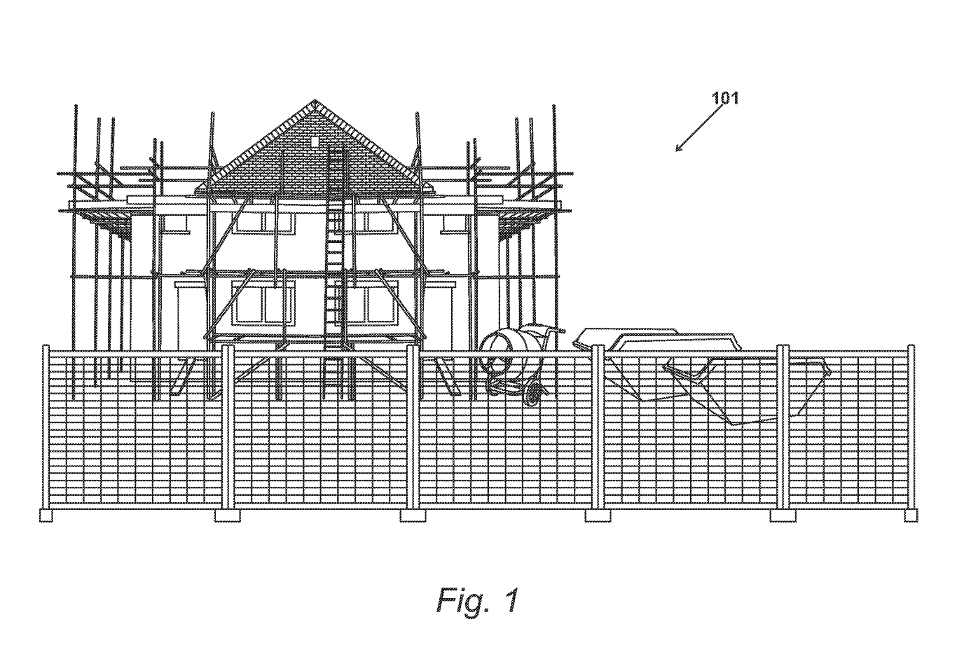

### FIG. 1

Fall arrest systems are required on sites where individuals are working at a height and thus at potential risk of injury if they fall to the ground. Ground is defined as the surface below which an individual is operative and may be represented by a lowermost surface or any surface that is lower than the level at which the individual is operative. Fall arrest systems break the fall of the individual and prevent or at least minimize potential injury.

Fall arrest systems may be required on a diverse range of sites on which individuals may be working at a height, for example, construction site 101 where individuals are working at height or on roofs, sites where solar panels are being installed onto roofs, sites at which action movies are being filmed and involve stunt men performing dangerous maneuvers, and sites on which individuals are working on airplane wings. This list is non-exhaustive and is intended to merely represent examples of sites wherein fall arrest systems may be required.

Known fall arrest systems include nets suspended under and around the sites where individuals are working at a height, harnesses and/or life lines worn by the individual workers and which are anchored to a fixed point and inflatable air bags placed under and around the site.

There are many problems associated with inflatable air bags of the prior art, in that they are both heavy and cumbersome to transport, and also that they rely on petrol-driven pumps to inflate and keep them erect. The fumes from these petrol-driven pumps are unpleasant for workers and pollute the air around the site.

There is therefore a need for an inflatable air bag which overcomes the problems associated with the prior art and this need is met by the present invention. The present invention provides a self-inflating system that is lightweight, portable and more environmentally friendly.

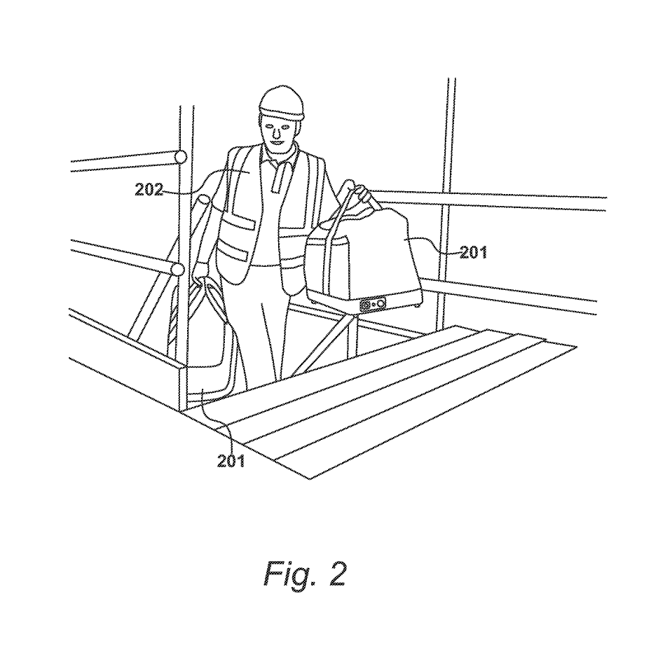

### FIG. 2

The present invention provides a self-inflating fall arrest system that is capable of staying erect for a working day. The invention comprises a system that can pack away in a bag or alternative receptacle, providing a lightweight product that is easily portable by a single worker 202. In the illustrated embodiment, bag 201 is a holdall or carryall style bag and weighs between 8 kg and 9 kg when containing the claimed self-inflating fall arrest system. The weight of bag 201 may however, vary considerably in alternative embodiments. The fact that the system is lightweight and easily portable allows for a reduction in transportation costs and space compared to the prior art.

In the illustrated embodiment, the self-inflating fall arrest system in an inflated state still remains attached to bag 201. However, in an alternative embodiment, the self-inflating fall arrest system does not necessarily need to remain attached to bag 201.

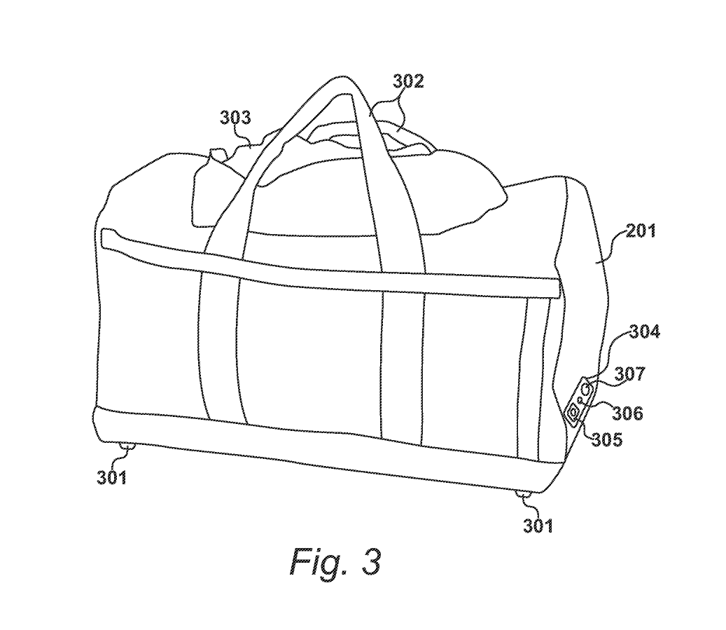

### FIG. 3

Bag 201 is shown in FIG. 3. In the illustrated embodiment, bag 201 is a holdall style bag or carryall type bag.

Feet 301 ensure that the base of bag 201 does not lie flush with the ground upon which it is stood, ensuring that air can circulate beneath the bag and be drawn up by the fan(s) inside the bag in order to inflate the fall arrest unit. In addition the base of bag 201 is composed of a mesh type fabric to allow air to pass through the base of bag 201. In the illustrated embodiment, bag 201 has four feet, although only two are visible in FIG. 3. In alternative embodiments, there may be an alternative number of feet on the base of each bag and in addition, there may be regions of mesh fabric on the sides or top of the bag.

Bag 201 comprises handles 302 so that bag 201 can be easily carried by an individual person.

Bag 201 comprises opening 303 from which the material of the fall arrest unit is taken out quickly and easily.

An external surface of bag 201 also displays panel 304 comprising charging point 305, fuse 306 and on/off switch 307.

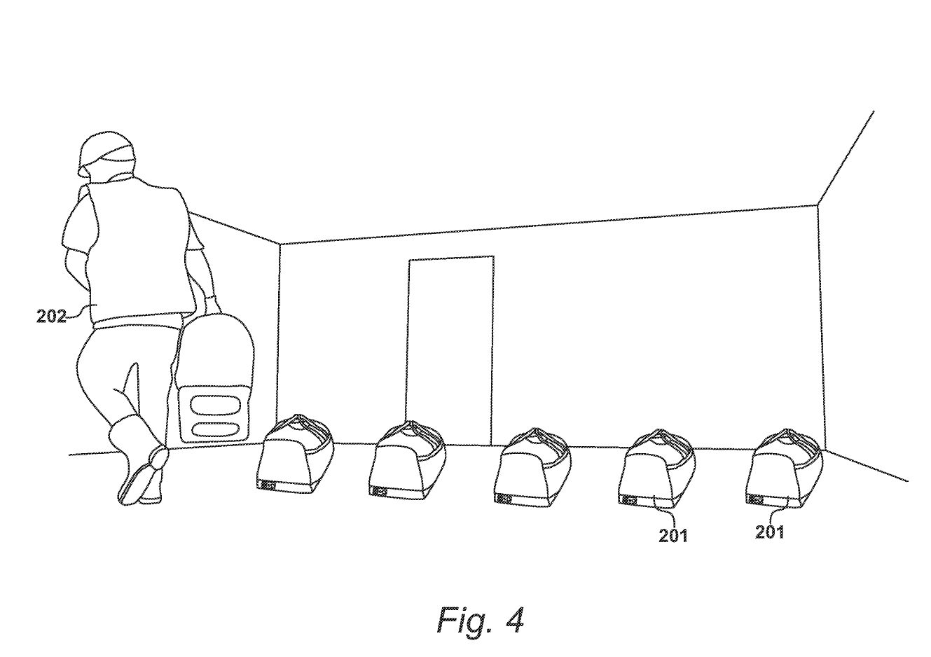

### FIG. 4

In the illustrated embodiment, bags 201 are easily carried by hand to the site where they will be used as a fall arrest system and are set out in a spaced apart position at the site above which individuals are working at height. A single individual 202, who can be an unskilled worker, is capable of carrying bags 201 to the site and setting them up as a fall arrest system. As clearly shown in FIG. 4, bags 201 are easily portable. In an alternative embodiment, bags 201 may be any sort of receptacle for containing the fall arrest units, such as any container, holder, vessel, tube, box, tin, case, crate, pouch or chest.

Carrying bags 201 to the site and setting them out on the floor can be carried out quickly and easily. The present invention eliminates the requirement for complicated decking, blowers and pipework which are associated with prior art fall arrest systems inflated by petrol-driven pumps.

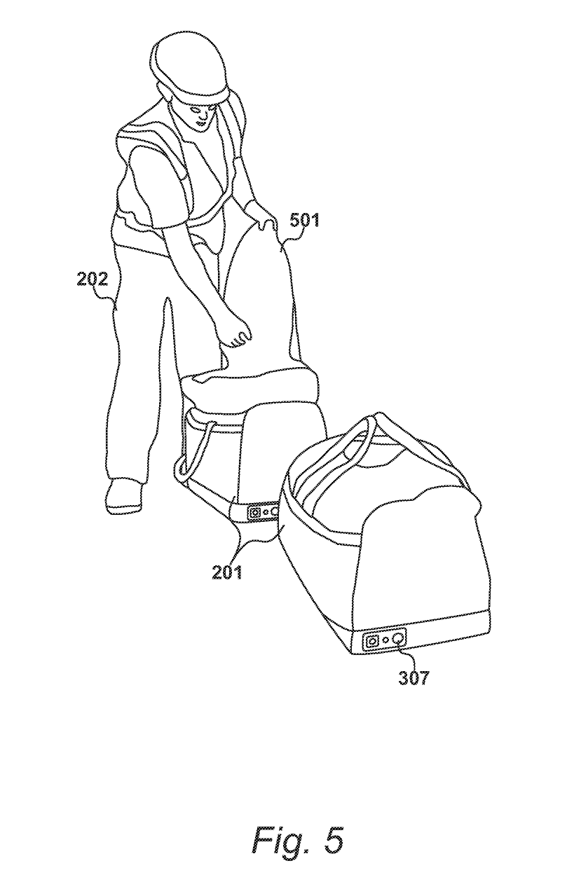

### FIG. 5

Once bags 201 are placed in position on the site above which individuals are to be working at height, the material 501 of each fall arrest unit is unpacked out of each bag 201. This unpacking procedure is quick and easy and can be performed by unskilled person 202. Material 501 of each fall arrest bag is typically fabricated from a high strength nylon or equivalent functional material.

Once unpacked, individual 202 presses on/off switch 307 on each of bags 201 to switch on a battery inside each of bags 201 which activates at least one fan (not shown in FIG. 5) inside each of bags 201. Activation of the fan causes air to be drawn into bag 201 and the air inflates the fall arrest unit.

In the illustrated embodiment, each fall arrest unit remains attached to its bag 201 or receptacle. However, alternatively, the battery activated fan(s) may be inside each fall arrest unit in which case the fall arrest unit is removed entirely from the bag or receptacle and does not remain attached to the bag 201 or receptacle while it is being inflated.

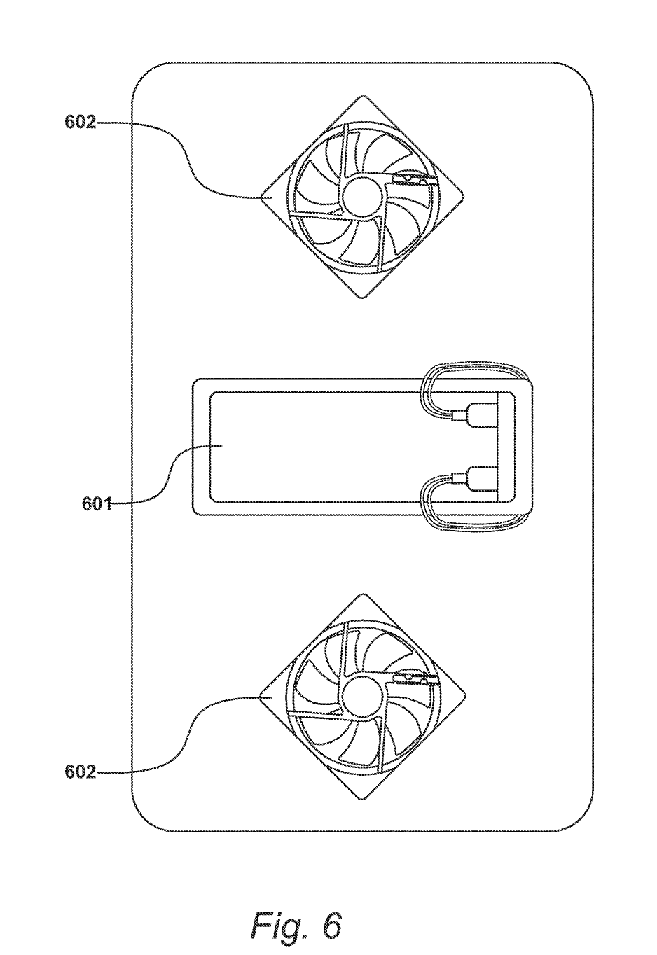

### FIG. 6

In FIG. 6, battery 601 and fans 602 are shown. Battery 601 and fans 602 may be either fixed to the base inside bag 201 (or alternative receptacle) or fixed inside each fall arrest unit. In the illustrated embodiment, battery is a 12 Volt 7 Amp Hour Sealed Lead Acid rechargeable battery which provides sufficient power for the fall arrest unit to remain erect during the course of a single working day, approximately eight hours.

Advantageously, battery 601 can be charged whilst remaining inside bag or receptacle 201 via engagement of charging point 306 (illustrated in FIG. 3) with a battery charger.

Any other suitable battery may be used, and in alternative embodiments, a battery having a higher amp-hour rating may be deployed in a situation where a longer battery life is required.

In the illustrated embodiment, fans 602 are 12V brushless fans but any other suitable fan may be deployed.

In the illustrated embodiment, it is preferable to have single battery 601 situated at the center of the base inside bag 201 or receptacle and fans 602 placed equidistantly either side of battery 601 because this ensures that there is an even weight distribution inside bag 201 or receptacle when bag 201 is carried.

In an embodiment, fans 602 are configured to operate at a first mode, in which the output is relatively high and a second mode, in which the output is reduced such that the first mode of operation utilizes a higher power output than the second mode of operation. The first mode is utilized to provide quick inflation of the fall arrest unit, and, once fully inflated, fans 602 operate on reduced power output so as to consume less power from battery 601 thereby allowing the fall arrest unit to operate for a longer period. It is appreciated that, in an alternative embodiment where a single fan is used, this dual output mechanism is also utilized.

Nevertheless, in alternative embodiments, there may be, for example, a single battery and a single fan, or there may be one or more batteries and one or more fans.

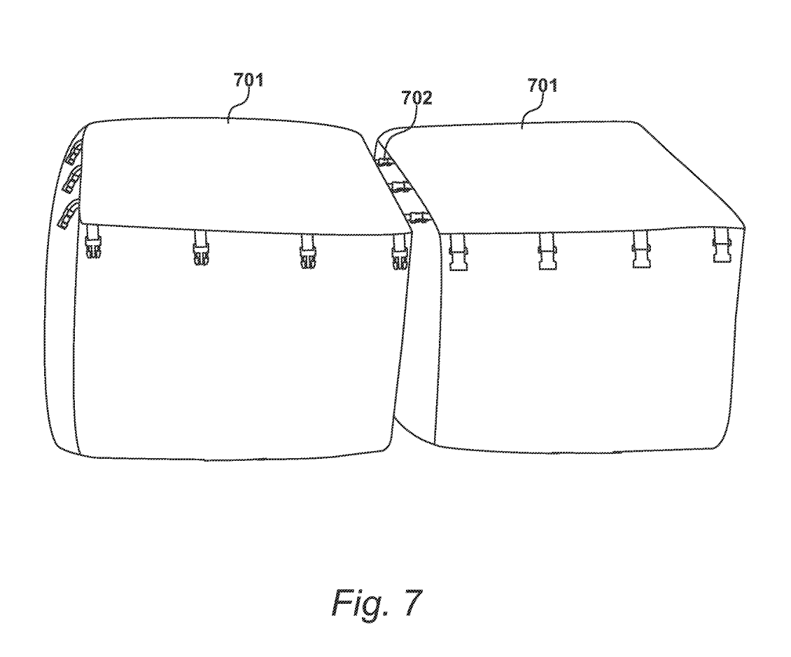

### FIG. 7

Once fully inflated, battery 601 (shown in FIG. 6) remains switched on to keep the fan or fans blowing to keep the fall arrest unit erect. In the illustrated embodiment, each fall arrest unit, once erect, is a standard 1.6 m in each diameter but alternative shapes (such as cylinders and rectangles) and diameters fall within the scope of the present invention.

Once erect, a first unit 701 is linked to a second unit 701. In the illustrated embodiment, buckle clips 702 are used to fasten a first fall arrest unit to a second fall arrest unit. However, in alternative embodiments, any other suitable type of fastener may be deployed.

In the illustrated embodiment, each of units 701 has been removed from its bag or receptacle. Thus, there is a least one battery-powered fan within each unit.

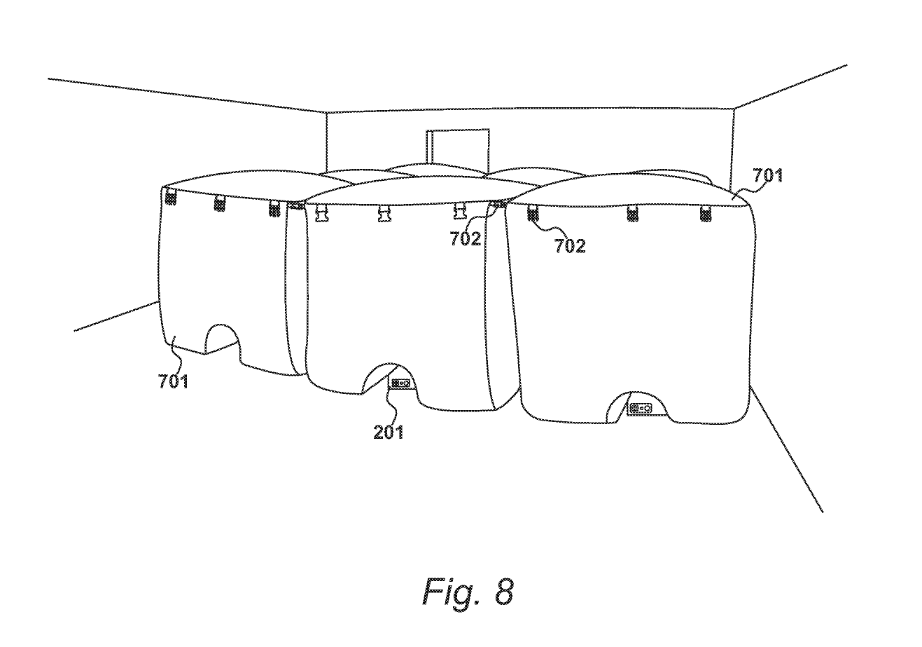

### FIG. 8

FIG. 8 shows a plurality of fall arrest units 701 linked together by buckle clips 702. They may be used as a fall arrest system at a range of sites which involve individuals working at height and thus being at risk of falling. These sites may include the area beneath airplane wings when engineers are carrying out checks and maintenance work on the wings, the area around houses when solar panels are being installed on the roofs, movie sets where individuals are performing stunts and any construction site.

The fall arrest system of the present invention has a number of advantages over prior art inflatable fall arrest systems in that it is easily portable by virtue of the bag or receptacle in which it is contained for transport, each individual unit is lightweight and therefore is safe to lift and handle and each unit is self-inflating. The fall arrest units 701 of the present invention can stay erect for a full working day and can be molded into shape once fully inflated to fit any shape of room without pushing over walls. The self-inflation of each fall arrest unit is carried out by at least one battery-powered fan and is thus environmentally friendly compared to known inflatable fall arrest systems which rely on petrol-driven pumps because the units do not emit noxious fumes.

The material of each fall arrest unit, which is typically fabricated from high-strength nylon, remains attached to receptacle 201, herein illustrated as a box.

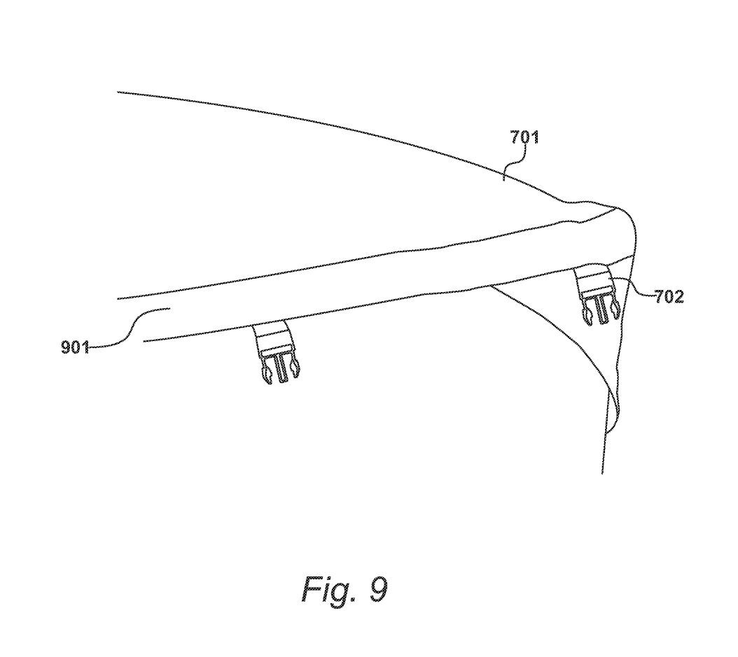

### FIG. 9

In the illustrated embodiment, flap 901 is an additional piece of fabric attached around top edge of fall arrest unit 701 which serves to cover the gap that arises between two fall arrest units once inflated and placed side by side. Flap 901 represents an additional safety feature to prevent an individual falling onto the fall arrest units and sliding down the gap between the fall arrest units.

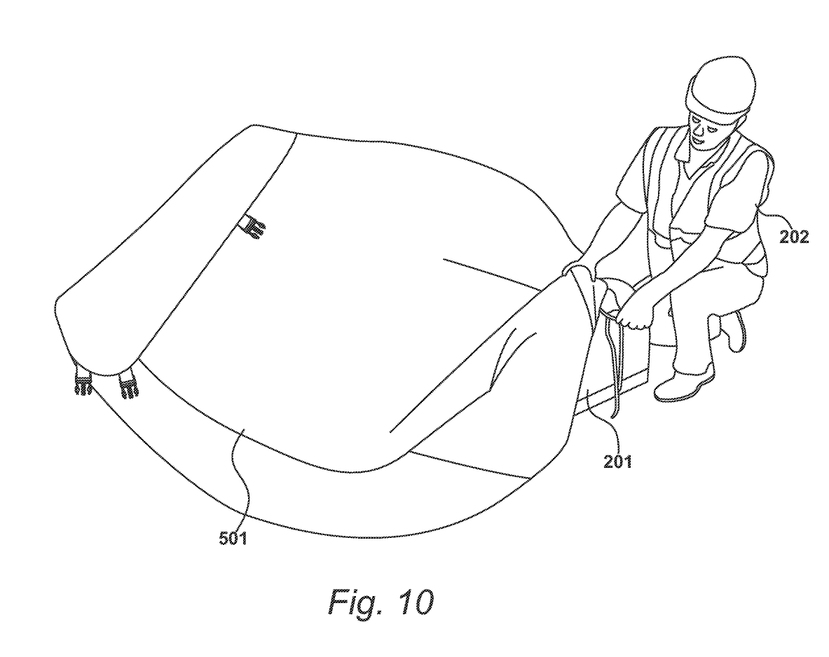

### FIG. 10

The material 501 of each fall arrest unit is easily and quickly packed away back into receptacle 201, here shown as a crate, after the work at height has been completed. Again, this procedure can be performed by an unskilled worker 202.

What we claim is:

1. A system for rendering safe a site above which an individual is operative at height, comprising:
at least one self-inflating fall arrest unit in a fully inflated state arranged at a ground location on said site, wherein
said at least one self-inflating fall arrest unit in a fully inflated state is configured to be linked to at least one other fully inflated self-inflating fall arrest unit; and
each said self-inflating fall arrest unit comprises at least one battery-powered fan.

2. A system according to claim 1, further comprising:
a plurality of self-inflating fall arrest units in a fully inflated state arranged at a ground location on said site, wherein each of said plurality of self-inflating fall arrest units in a fully inflated state is linked to at least one other fully inflated self-inflating fall arrest unit.

3. A system according to claim 1, wherein each said self-inflating fall arrest unit is packed in a bag or receptacle when in a deflated state.

4. A system according to claim 3, wherein each said self-inflating fall arrest unit packed in a bag or receptacle in a deflated state is portable.

5. A system according to claim 3, wherein each said self-inflating fall arrest unit remains attached to said bag or receptacle when in a fully inflated state.

6. A system according to claim 5, wherein said bag or receptacle comprises a plurality of feet attached to the surface of said bag in contact with the ground.

7. A system according to claim 1, wherein each said self-inflating fall arrest unit comprises two battery-powered fans.

8. A system according to claim 1, wherein said at least one battery-powered fan utilizes a rechargeable battery.

9. A system according to claim 1, wherein said at least one battery-powered fan is operable in a first mode of operation and a second mode of operation, in which said first mode utilizes a higher power output than said second mode.

10. A system according to claim 1, wherein each said self-inflating fall arrest unit is fabricated from high strength nylon.

11. A system according to claim 1, wherein each said self-inflating fall arrest unit in a fully inflated state remains in a fully inflated state for at least eight hours.

12. A system according to claim 1, wherein each said self-inflating fall arrest unit in a fully inflated state is molded into the area into which it is fitted.

13. A system according to claim 1, wherein each said fall arrest unit is deflated and packed into a bag or receptacle after use.

14. A system according to claim 1, wherein each said fall arrest unit in a fully inflated state is linked to at least one other fully inflated fall arrest unit by a fastener.

15. A system according to claim 14, wherein said fastener is a buckle clip.

16. A method for rendering safe a site above which an individual is operative at height, comprising the steps of:
placing a plurality of self-inflating fall arrest units at a ground location on said site, wherein said self-inflating fall arrest units are in a deflated state;
actuating at least one battery-powered fan inside each of said plurality of self-inflating fall arrest units;
allowing each of said plurality of self-inflating fall arrest units to self-inflate to a fully inflated state; and
locking each of said plurality of self-inflating fall arrest units in a fully inflated state to at least one other fall arrest unit in a fully inflated state.

17. A method according to claim 16, further comprising the steps of:
deflating said self-inflating fall arrest units; and
packing said self-inflating fall arrest units into a bag or receptacle after use.

18. A method according to claim 16, further comprising the steps of:
operating said at least one battery-powered fan in a first mode of operation at a first power output; and
operating said at least one battery-powered fan in a second mode of operation at a second power output, said first power output being higher than said second power output.

19. A method according to claim 16, wherein said bag or receptacle comprises a plurality of feet attached to the surface of said bag, and said method further comprises placing said plurality of feet in contact with the ground.

20. A method according to claim 16, wherein said step of locking comprises linking each said fall arrest unit to at least one other fall arrest unit by means of a fastener.
